(19) United States
(12) Patent Application Publication
(10) Pub. No.: US 2009/0142487 A1
(43) Pub. Date: Jun. 4, 2009

(54) Quick-polymerization styrene-maleic anhydried copolymer surface reinforcement and hardening of wood, wood products and other porous materials

(76) Inventor: Marc Henry Schneider, Fredericton (CA)

Correspondence Address: Ralph A. Dowell of DOWELL & DOWELL P.C., 2111 Eisenhower Ave, Suite 406, Alexandria, VA, 22314, US

(21) Appl. No.: 11/987,570

(22) Filed: Nov. 29, 2007

(51) Int. Cl. B05D 5/00

(52) U.S. Cl. 427/243

(57) ABSTRACT

This invention provides methods for preparing mixtures of styrene and maleic anhydride co-monomer, applying that mixture to the surface of a solid porous substance like wood, allowing the mixture to penetrate the surface zone of the material such as wood and causing it to quickly cure in the surface zone of the material. The keys are the low viscosity of the mixture that causes it to penetrate quickly and well, and its reactivity that causes it to cure before it either evaporates or becomes too dispersed within the material. The polymer reinforcement and hardening is therefore effectively restricted to the surface zone or shell. This produces a reinforced, hardened, protective shell around the porous material.

### FIELD OF THE INVENTION

This invention relates to styrene-maleic anhydride copolymer and its use for quick-polymerization surface reinforcement and hardening of wood, wood products and other porous materials.

### BACKGROUND OF THE INVENTION

Wood surfaces are typically soft. They collect soil and are difficult to clean. They easily absorb water and other liquids. Outdoors, they are subject to breakdown by weathering. As a result, exposed surfaces of wood products are usually coated with a polymeric film of some type. Earlier films were made from natural resins and drying oils. More recent ones incorporate modern polymers. However, coatings are basically films of polymer sitting on, and usually well-attached to, the wood substrate. They do protect the surface from soiling and the effects of weather to a certain extent. And they do harden the surface slightly.

However, coating films have limited hardening and protecting capabilities. That is because they are films. The films are typically thin and therefore on their own have little resistance to indentation. The wood below them reinforces the film, but the combination of wood and film is little harder than the wood alone. Even thick, hard films which are used on some flooring, have limited hardness and abrasion resistance. Because coatings are films attached to the surface, there is a boundary layer that can be susceptible to breakage, releasing the film from the surface. This is particularly evident when water causes paint blistering and detachment. Also, because the coating is a film, when the film is breached mechanically or by weathering, the wood beneath is left unprotected.

There have been many attempts made to overcome these shortcomings of coating films. The main approach has been to modify coatings formulations to improve their adhesion and resistance to deterioration. However, this approach has limitations because there are still two different substances, one on top of the other. Each of these substances has weaknesses that can only be improved a limited amount by the proximity of the other. To make a large improvement in properties, a true combination of substances at the surface is needed.

The present inventor has developed technologies that make wood and wood products into true composites of wood and polymer throughout. However, there are several challenges that must be overcome before useful surface impregnating solutions and processes for wood can be developed.

To make the improvement in properties as discussed above, a low molecular weight, low viscosity liquid is forced into wood using vacuum and pressure and the liquid is then polymerized inside the wood. The resulting composite is harder, more resistant to moisture and biodeterioration, and stronger than the original material. However, whenever only surface enhancement is needed, this composite material is not suitable. It is too heavy and expensive. In the past, the inventor has attempted to penetrate a limited amount of the liquid using the vacuum and pressure process, but was unable to obtain sufficient control and make a useful product. There was wide variation in penetration between different pieces of wood, and where there was usefully deep penetration, it was too deep due to a lack of control over wood porosity variability.

The vacuum and pressure process for treating wood is useful for obtaining deep fluid penetration and retention. It is the only practical method that has been found to be industrially useful for protecting wood from biodeterioration in harsh environments. Likewise, it has been the only practical method for producing wood modified with polymer. However, this process requires that products be treated in batches that will fit inside a vacuum-pressure cylinder. These cylinders and their associated equipment are large and expensive. Most processes that make wood products (such as sawmills, plywood mills and oriented strand board plants) are continuous. Introducing a batch process into one of these mills requires a break in the continuous production.

Coatings do not protect wood from biodeterioration in environments that are conducive to such deterioration. Sometimes they increase the rate of decay by keeping wood moist. Preservatives and wood modifications do not always need to completely penetrate the wood to provide useful protection from biodeterioration. Often, all that is required is a treated shell. This shell is biodeterioration-resistant and, because it surrounds the core of the product, protects that zone as well.

Therefore, there is a need for an efficient and economical method of applying protective coatings to porous surfaces such as wood products.

### SUMMARY OF THE INVENTION

The present invention provides styrene-maleic anhydride copolymer and its use for quick-polymerization surface reinforcement and hardening of wood, wood products and other porous materials.

More particularly, embodiments of the present invention provide chemical formulations and a process of use of the formulation that produces a hardened, biodeterioration-resistant and moisture-resistant shell on wood and wood products surfaces. The formulation is a styrene-maleic anhydride chemical formulation which has sufficiently low viscosity to flow and penetrate into the zone near the surface and is sufficiently reactive so that the formulation can be quickly “fixed” in the wood, preventing evaporation to the outside or excessive penetration to the inside.

In one aspect of the invention there is provided a method for surface reinforcement and hardening of porous materials having porous surfaces, comprising the steps of:

a) mixing styrene monomer and maleic anhydride co-monomer in pre-selected proportions at a temperature above room temperature to produce a mixture of the styrene monomer and the maleic anhydride, the temperature being sufficiently high to prevent precipitation of the maleic anhydride co-monomer;

b) applying the mixture to the porous surface to be modified; and

c) curing the mixture under conditions effective to cause the mixture to copolymerize within the porous surface and on the porous surface to form a hardened surface reinforcement.

This formulation was made from two readily-available, inexpensive chemicals. It produced a copolymer upon polymerization using heat but no catalyst or crosslinker.

### DETAILED DESCRIPTION OF THE INVENTION

The methods described herein are directed, in general, to styrene-maleic anhydride copolymer and its use for quick-polymerization surface reinforcement and hardening of wood, wood products and other porous materials. Although embodiments of the present invention are disclosed herein, the disclosed embodiments are merely exemplary.

Therefore, specific structural and functional details disclosed herein are not to be interpreted as limiting but merely as a basis for the claims and as a representative basis for enabling someone skilled in the art to employ the present invention in a variety of ways. For purposes of instruction and not limitation, the illustrated embodiments are all directed to embodiments of styrene-maleic anhydride copolymer and its use for quick-polymerization surface reinforcement and hardening of wood, wood products and other porous materials.

As used herein, the term “about”, when used in conjunction with ranges of concentrations of constituents of various formulations or other physical properties or characteristics, is meant to cover slight variations that may exist in the upper and lower limits of the ranges of concentrations so as to not exclude embodiments with concentrations slightly above or below those recited herein. It is not the intention to exclude embodiments such as these from the present invention.

Normally when polymerizing a vinyl monomer such as styrene at atmospheric pressure and moderate (up to its boiling point) temperature to improve wood properties, an initiator is needed. These initiators are usually an organic peroxide or a nitrile. Additionally, a di- or tri-functional crosslinking agent is normally added to improve machining and sanding properties. The initiators and crosslinkers are expensive.

Styrene-maleic anhydride mixtures are unusual because they copolymerize quickly and spontaneously, without an initiator, at about 80° C. Since the reaction is exothermic, once started it tends to continue to completion. The styrene-maleic anhydride (SMA) copolymer formed is hard and has some amount of crosslinking because of the crosslinking provided by the maleic anhydride (MA) co-monomer. MA co-monomer also has potential to bond to wood substance, anchoring the SMA polymer more firmly than is possible with styrene alone. In the past, the inventor has tried using SMA for making modified wood using a vacuum-pressure process, but found its reactivity insufficiently controllable to make it a practical chemical for this purpose. Even at room temperature, it quickly gels. Any formulation remaining on the wood surface or in the equipment thus becomes quickly useless, and can cause a cleanup problem.

The inventor has very surprisingly discovered that mixing styrene and maleic anhydride co-monomer in the proper proportions, applying it to a porous surface (such as wood) and as it penetrates causing it to quickly form a styrene-maleic anhydride (SMA) copolymer in the penetrated surface zone, the fast polymerization limits penetration to the shell zone. The original SMA solution has low viscosity which allows easy penetration into the porous surface zone. The fast polymerization “fixes” the SMA in the shell in a useful concentration. So the use of SMA requires a particular process to be useful. The basic process is to immerse, spray, curtain coat, brush or roll the SMA monomer solution onto the porous material like wood or wood products and then heat the penetrated zone of the porous material.

Immediately after the penetration, the surface heating solidifies the SMA into a polymer before it can become too disperse. The surface zone of the material is therefore reinforced and the untreated core is therefore protected by the treated shell.

### Method

Styrene monomer and MA were mixed, forming a solution. MA is a solid at room temperature and styrene a liquid. At room temperature, the solubility of MA in styrene is less than optimum for the purposes of this invention, so mixing of the solution was done above room temperature to allow higher concentration of MA to be dissolved in styrene. A tracer dye can be added to the styrene to allow a penetration depth to be easily seen. If no dye is used, the mixture is clear and does not change the color of the treated material.

Pot life is about 5 to 10 minutes at 80° C., depending on batch size. The solution gradually begins to polymerize at this temperature, auto-accelerating to completion in 10 to 15 minutes after mixing. The mixing proportions used were equal parts by weight of styrene monomer and MA. When polymerizing, they copolymerize in this ratio. However, less MA can be used for different effects. The mixture is then applied to the porous surface to be modified. Application can be done by brush, roller, spray, curtain coater, dipping or any other suitable method.

The mixture penetrates almost instantaneously. It is cured by elevating the temperature of the zone where it is present. Heating can be accomplished by contact (such as heated platens), infrared, high frequency or any other method that raises the temperature of the outer zone of the material. The heating causes the mixture to copolymerize, thereby reinforcing the zone where it is present. The process can be repeated several times to obtain higher loading and therefore greater property change. This process can be carried out in a continuously moving line or in batches.

The present invention will be illustrated with the following examples. They are not intended to limit the scope of this disclosure to the embodiments exemplified therein.

### EXAMPLE 1

Mixing and curing was as follows:
1. Styrene monomer at about 80° C. was mixed 50/50 by weight with maleic anhydride co-monomer.
2. The mixture was maintained at about 80° C. until it was spread on the surface. If allowed to cool, the MA co-monomer precipitates.
3. The mixture was brushed (while hot) onto a southern yellow pine oriented strand board surface.
4. The material was placed in a hot press at 145° C. (light contact) for 3 minutes. This caused complete polymerization in the full depth of penetration.

While a preferred mixing proportion as mentioned above is 50/50, it will be appreciated that mixing proportions in a range from about 50/50 to about 80/20 parts by weight of the styrene monomer and the maleic anhydride co-monomer may be used. While the curing mentioned above in step 4. was at 145° C., it will be appreciated that curing may be conducted at a temperature in a range from about 80° C. to about 160° C. and the time for curing adjusted accordingly.

Penetration occurred almost instantaneously. Penetration depth was 4 to 7 mm in some places and went to the center of the sample in some other places. However, the amount of polymer in the surface zone was not as great as desired. So the process was repeated twice to give full polymer saturation within a 3 to 4 mm surface zone.

The material formed this way was sanded in a power sander. Wood modified with linear, vinyl polymers and sanded this way will soften on the surface and load the sandpaper. This is one reason why a crosslinker is normally added. However, the SMA polymer reinforced surface formed by the method described herein softens only slightly when sanded, indicating it has some crosslinking. By comparison, more softening occurs with this polymer than for di-vinyl benzene cross-linked styrene but not as much softening as with linear polystyrene.

The 50/50 SMA copolymer had a hardness of about 90 Shore D (Brinell hardness number 27) which is approximately the same as cross-linked poly-methyl methacrylate, a hard vinyl polymer. In comparison, di-vinyl benzene cross-linked polystyrene (containing no MA) has a Shore D hardness of about 85 which is noticeably softer since the Shore D scale is not linear.

As used herein, the terms “comprises”, “comprising”, “includes” and “including” are to be construed as being inclusive and open-ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

What is claimed is:

1. A method for surface reinforcement and hardening of porous materials having porous surfaces, comprising the steps of:
a) mixing styrene monomer and maleic anhydride co-monomer in pre-selected proportions at a temperature above room temperature to produce a mixture of the styrene monomer and the maleic anhydride co-monomer, the temperature being sufficiently high to prevent precipitation of the maleic anhydride co-monomer;
b) applying the mixture to the porous surface to be modified; and
c) curing the mixture under conditions effective to cause the mixture to copolymerize within the porous surface and on the porous surface to form a hardened surface reinforcement.

2. The method according to claim 1, including repeating steps b) and c) a pre-selected number of times to build up a pre-selected number of layers.

3. The method according to claim 1 carried out in a continuously moving production line or in batches.

4. The method according to claim 1 carried out in batches.

5. The method according to claim 1 wherein said mixing proportions are equal parts by weight of the styrene monomer and the maleic anhydride co-monomer.

6. The method according to claim 1 wherein said porous material is wood or a wood product.

7. The method according to claim 1 including adding a tracer dye to said mixture to allow penetration depth of the mixture into the porous material to be monitored or to change the color of the material.

8. The method according to claim 1 wherein said step c) of curing is accomplished by elevating the temperature of the area of the porous material to which the mixture is applied.

9. The method according to claim 8 wherein the temperature is elevated using any one or combination of physical contact using heated platens, infrared and high frequency radiation.

10. The method according to claim 1 wherein said mixing proportions are in a range from about 50/50 to about 80/20 parts by weight of the styrene monomer and the maleic anhydride co-monomer.

11. The method according to claim 1 wherein step a) is performed with the styrene monomer at about 80° C.

12. The method according to claim 1 wherein said step c) of curing is conducted at a temperature in a range from about 80° C. to about 160° C. for a pre-selected time.
